(19) United States
(12) Patent Application Publication
(10) Pub. No.: US 2023/0385751 A1
(43) Pub. Date: Nov. 30, 2023

(54) SYSTEM AND METHOD FOR TRACKING SHIPPING CONTAINERS

(71) Applicant: Alfonso Llanes, Miami, FL (US)

(72) Inventor: Alfonso Llanes, Miami, FL (US)

(21) Appl. No.: 18/203,589

(22) Filed: May 30, 2023

Related U.S. Application Data
(60) Provisional application No. 63/346,724, filed on May 27, 2022.

(51) Int. Cl. G06Q 10/0833; G06K 7/14; G06K 19/06

(52) U.S. Cl. CPC G06Q 10/0833; G06K 7/1417; G06K 19/06037

(57) ABSTRACT

A system and method for tracking shipping containers uses QR codes that are affixed to each container providing extensive data that is particular to each container, including the size of the container, the weight of the container, as well as the location of the container upon scanning the QR code with a QR scanning device, such as a smartphone. The system and method of the present invention further incorporates the use of a website and software that allows for a setup of automated emails and notifications, as well as communication with the devices that scan the QR code on each container.

### BACKGROUND OF THE INVENTION

This non-provisional patent application is based on provisional patent application Ser. No. 63/346,724 filed May 27, 2022.

### FIELD OF THE INVENTION

This invention relates to tracking the location and movement of shipping containers and, more particularly, to a system and method that uses QR codes affixed to each shipping container that allows for scanning, location tracking and other identification of any particular shipping container.

### DESCRIPTION OF THE RELATED ART

Most goods are shipped across country and overseas in steel or aluminum shipping containers that are carried by merchant ships, trucks and trains from their point of origin to the final destination. The need to constantly identify and track the location of shipping containers has become an increasing concern to shipping companies, manufacturers, merchants, shipping container owners and government agencies, including homeland security. In the past, others have proposed various devices and methods for identifying the location of shipping containers and, in some cases, tracking the movement of shipping containers within a shipyard, on highways, and overseas. Some of these proposed methods involve the use of radiofrequency identification devices (RFID) that are attached to the shipping container. This method has been proven to be unsatisfactory, as it is limited by poor scalability, RF noise and interference, lack of real-time alerting, as well as short range of the infrastructure that is required to read and communicate with the RFID devices. Others have proposed the use of Global Positioning System (GPS) technology that requires use of GPS receivers, processors and batteries. Still others have proposed use of radio transmitting devices that also require the use of battery powered devices that are attached to the containers. The problem with GPS and radio transmission devices is that the devices on the containers require battery operation and eventually the battery power is depleted, requiring replacement and/or recharging of the batteries in each of these devices on each individual container. This constant need to replace or recharge batteries is not practical and results in a large percentage of containers being moved around the world having no battery power in the tracking devices attached to the containers. Additionally, the use of these devices requires a clear path for signal reception and transmission. When containers are stacked, one upon another, or located in cargo holds on a ship, the signal transmission is blocked and, therefore the container cannot be identified or tracked.

There remains an urgent and definite need for a highly reliable system and method for identifying and tracking shipping containers around the world, in real-time.

### SUMMARY OF THE INVENTION

The present invention is directed to a system and method for tracking the location and movement of shipping containers. The invention proposes use of QR codes that are affixed to each shipping container providing extensive data that is particular to each container, including the size of the container, the weight of the container, as well as the location of the container upon scanning the QR code with a QR scanning device, such as a smartphone. The system and method of the present invention further incorporates the use of a website and software that allows for a setup of automated emails and notifications, as well as communication with the devices that scan the QR code on each container.

### BRIEF DESCRIPTION OF THE DRAWINGS

For a fuller understanding of the nature of the present invention, reference should be had to the following detailed description taken in connection with the accompanying drawings in which:

FIG. 1 is a plan view of a typical CSC plate that is affixed to shipping containers providing the information presented thereon;

FIG. 2 is a schematic diagram illustrating the transmission, receipt and flow of data for a shipping container, using the scanning of a QR code affixed to the container, according to the system and method of the present invention; and

FIG. 3 is a tracking map illustration that is presented on a computer monitor using the system and method of the present invention, displaying the GPS scanned location of shipping containers on the map.

### DETAILED DESCRIPTION OF THE PREFERRED EMBODIMENT

The present invention proposes use of QR codes that are affixed to each container providing extensive data that is particular to each container, including the size of the container, the weight of the container, as well as the location of the container upon scanning the QR code with a QR scanning device, such as a smartphone. The system and method of the present invention further incorporates the use of a website and software that allows for a setup of automated emails and notifications, as well as communication with the devices that scan the QR code on each container.

A discussion of the technical aspects of QR codes is set forth below. The use of QR codes in the system and method of the present invention provides for a convenient and highly effective means for identifying and tracking shipping containers without the need for any battery power on the containers. Another advantage of using QR codes in the system and method of the present invention is that QR Codes can sustain up to 30% of structural damage and still continue to function.

The images below show what a typical QR code looks like with the desired information masked behind what appears to resemble a maze.

QR Codes can store up to 7,089 numeric or 2,953 alphanumeric characters.

### Some Applications of Qr Codes

1. Contact Data—Data is stored in a contact card and can include a person's name, phone number, email address, website and others.
2. Calendar Data—This can include a calendar appointment that can be saved directly into someone's diary when scanned.
3. URL—This is simply a URL that when scanned would be used by a smartphones browser to take a user a given webpage. (The present invention uses this application of QR codes.)
4. Email Address—This could be used to open a blank email with a predefined subject and recipient ready for the user scanning to add content and send.
5. Phone Number— A phone number that when scanned would appear directly in a phones dialer ready to dial or would be saved to the address book.
6. SMS— A new SMS could be opened ready to send to a predefined recipient. (This is another application that is intended to be used in the present invention.)
7. Plain Text—Text can be included that may not have a predefined function but could be used by a bespoke application to carry out any given task. You can store up to 7,089 characters of numerical data or 4,296 alphanumerical characters in a standard QR Code. Micro QR Codes can hold up to 35 numeric symbols.
8. Geo Location— A link to a location that when scanned, can be processed by the reader and used to give directions to an event. (This is another application that is intended to be used in the present invention.)

### QR Geometry

The modules in a QR symbol can be grouped into several distinct components, for example:

### The Fixed Pattern

Position symbols and their borders

These position symbols are used by the device attempting to read the symbol. They fix the rotation and basic dimensions.

The number of alignment symbols grows with the size of the symbol. For version 4040 (of size 177×177×177), explaining their function, and presumably they help correct for perspective, curvature, and other distortion.

Timing Arrays

Timing arrays help to determine the dimensions of the symbol.

### Variable Data

The components so far do not vary with the message, and are not subject to interpretation. They are fixed for each size. The following components listed below convey information. The first two provide information about choices made that determine interpretation, and the rest are part of the actual message.

Format Information

This contains two pieces of information, the level of error correction chosen, and the index of the mask laid over the original message. Because it is crucial to be able to read this, it is stored in several places.

The basic format information is a sequence of bits, 00 through 1414.
Message Bits
These contain the actual message. More information about the message bits component and the other parts of the data bytes is provided hereinafter.
Padding
For a given choice of size and error correction level, the number of available words for a message is fixed. But since the message might be somewhat shorter than what is allowed, it is padded with a more or less fixed pattern of bits to fill up space.
Error correction bits
These implement one of the standard BCH coding schemes.

### The Mask

The data bits in the symbol must be unmasked to see the original data bits. The mask id in the example QR code shown below is 010010, and this mask is indicated by the pattern of spaced square marks. In other words, the mask amounts to columns of modules 33. The fixed pattern is not masked, nor is the format bits (which have their own mask).

The modules are now numbered. The modules belonging to the fixed pattern and the ones belonging to the format region and the version are not numbered, so the numbering scheme has to avoid them. Basically, the numbering starts at the lower right, chooses next its left neighbor, and proceeds alternately up and down columns of width 22, choosing as its next module the first available according to the avoidance rules:

Groups of eight modules are arranged into bytes. This grouping plays a role only in case error correction is necessary, which it is not here. (The bytes are interpreted as elements in the Galois field of order 256256 in the BCH codes.) In the following diagram, the original data bits are black and grouped in bytes.

Other Applications of QR Code
QR for bus schedules
QR on tombstones
QR for parking meters
QR parking
QR can find your parked car
QR on menus
QR art
Other uses of QR

The four encoding modes include the following characters:

Numeric mode is for decimal digits 0 through 9.

Alphanumeric mode is for the decimal digits 0 through 9, as well as uppercase letters (not lowercase!), and the symbols $, %, *, +, −, ., /, and : as well as a space. All of the supported characters for alphanumeric mode are listed in the left column of the alphanumeric table.

Byte mode, by default, is for characters from the ISO-8859-1 character set. However, some QR code scanners can automatically detect if UTF-8 is used in byte mode instead.

Kanji mode is for double-byte characters from the Shift JIS character set. While UTF-8 can encode Kanji characters, it must use three or four bytes to do so. Shift JIS, on the other hand, uses just two bytes to encode each Kanji character, so Kanji mode compresses Kanji characters more efficiently. If the entire input string consists of characters in the double-byte range of Shift JIS, use Kanji mode. It is also possible to use multiple modes within the same QR code, as described hereinafter.

Extended Channel Interpretation (ECI) mode specifies the character set (e.g. UTF-8) directly. However, some QR code readers do not support ECI mode and will not understand QR codes that use it.

Structured Append mode encodes data across multiple QR codes, up to a maximum of 16 QR codes.

FNC1 mode allows the QR code to function as a GS1 barcode.

It is possible to use multiple modes in a single QR code by including the mode indicator before each section of bytes that uses that mode. The QR code specification explains how to switch modes in the most optimal way.

Before encoding the data, select an error correction level. QR codes use Reed-Solomon error correction. This process creates error correction code words (bytes) based on the encoded data. A QR code reader can use these error correction bytes to determine if it did not read the data correctly, and the error correction code words can be used to correct those errors. There are four levels of error correction: L, M, Q, H. The following table lists the levels and their error correction capabilities.

| Error Correction Level | Error Correction Capability |
|---|---|
| L | Recovers 7% of data |
| M | Recovers 15% of data |
| Q | Recovers 25% of data |
| H | Recovers 30% of data |

Error correction requires more bytes, so the higher the error correction level, the larger the QR code will have to be.

| Encoding Mode | Maximum number of characters a 40-L code can contain |
|---|---|
| Numeric | 7089 characters |
| Alphanumeric | 4296 characters |
| Byte | 2953 characters |
| Kanji | 1817 characters |

### Static QR Code?

Static QR Codes are QR Codes that can't be changed once they are created. These are, for example, email and text Codes, which don't gather any tracking metrics.

### Dynamic QR Code?

While Static QR Codes contain fixed information, Dynamic QR Codes have the possibility to be edited after completion. Both the type of QR Code and the content are editable as many times as needed. They use a short URL to send users to the landing page of your desire as well as monitor statistics for information such as the number of scans, location and operating system used.

Static vs Dynamic QR Code, using the latter allows for QR Code tracking. Scan metrics include time scanned, location scanned by city or country, operating device used, and unique vs. total scans. This information not only enables you to use QR Codes for product inventory management and/or container templates, it also allows you to compare them across different time periods and locations.

According to the system and method of the present invention, when each container arrives at a port, the receiving vehicle (truck, rail) operator scans the QR code printed on the container being transported on the truck. Typically, scanning the QR code is accomplished with a standard cell smart phone which can then be tracked by GPS. Scan metrics include container ID and the particulars of origin-destination time scanned, location scanned by port-city and the operating device used.

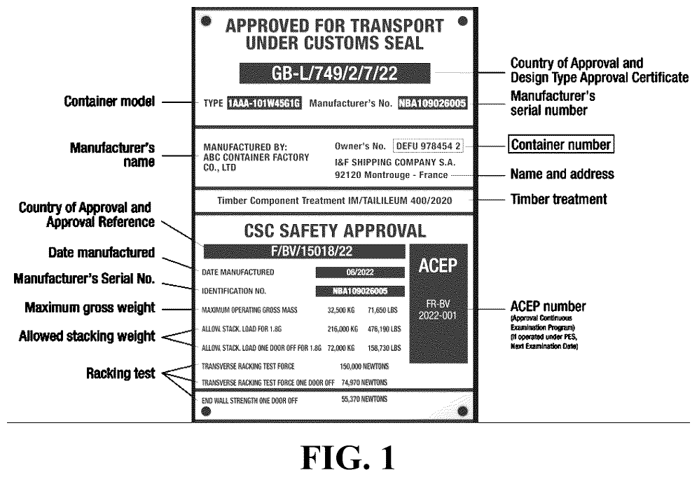

Referring to FIG. 1, an example of a typical CSC plate is shown containing important safety approval information about the shipping container. The International Convention for Safe Containers (CSC) certifies that the container is a safe container because it has been tested according to strict procedures and meets specific requirements. The International Convention for Safe Containers requires that any container used for international transport must be fitted with a valid safety approval plate (CSC plate). The CSC plate is fastened to every shipping container at the time of manufacture and is typically riveted to the outside of the left door of the container. All of the information on the CSC plate can also be incorporated within the QR code. The QR code may not replace the CSC plate, but can still contain all of the safety approval information presented on the CSC plate, as well as other data that may change from time to time, such as the particular contents of the container, which obviously is temporary information that will change with each separate transport of the container from an initial shipping point to a final destination.

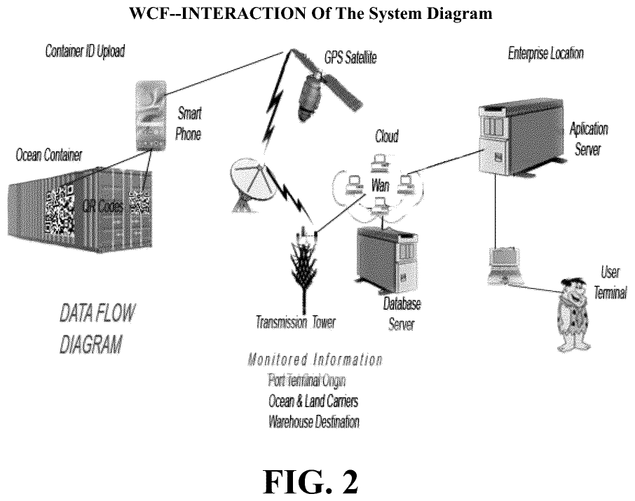

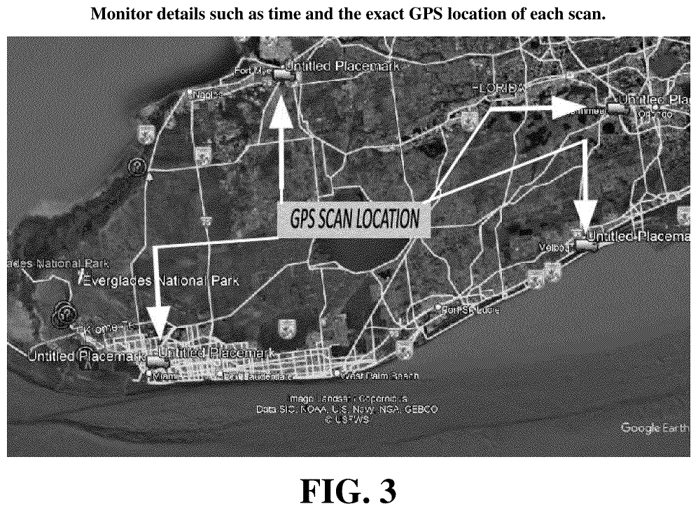

Referring to FIG. 2, the flow of scanned data from the QR code is illustrated. As mentioned above, the QR code affixed to the outside of the shipping container is initially scanned, typically with the use of a standard cell smartphone, which then transmits the scanned data via a GPS satellite to a transmission tower or antenna. From there, the data is directed to a database server. More particularly, the scanned data from the QR code, including all information relevant to the container, is uploaded to a website with software that allows set up of automated emails and in-app notifications. Thereafter, important notifications are sent to shipping companies, container owners and other interested parties. This information includes details about the container type, size, contents, current location and other particulars, along with ETA at destination. This software is Web-based asset tracking software that can be integrated with a number of other business software.

Dynamic QR codes applied to each shipping container contain URLs to entire container location management websites. Scanning the dynamic QR code on a shipping container will automatically open up a website or even a specific page within the site in the cloud.

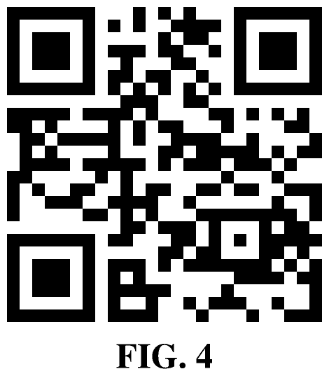

A third-party user can login to the server and enter the container characteristics desired. An automatic match is made with the dynamic inventory of container-type layered over a geographic area based on collected data per shipping cycle. An automated email notification is sent to the inquiring party when a match is made (i.e., the particular shipping container is identified, including all tracking information). Referring to FIG. 3, an example of a GPS map display that is presented on the user's computer terminal (e.g., desktop or laptop computer) is shown. This GPS map display will illustrate the current physical location of all shipping containers that have been identified in the search by the user. This may be a single shipping container, or multiple shipping containers that may be in the same geographic area or anywhere in the world.

Additionally, the system generates automated email notifications to the carriers-owners of a container-match so that a freight rate and a booking can be made for return voyage. The entire process is repeated for the new booked cargo applying and using the same methodology.

What is claimed is:

1. A method for tracking shipping containers comprising the steps of:
creating a QR code specific to each of a plurality of shipping containers and the created QR code containing specific identifying information concerning a particular shipping container among the plurality of shipping containers;
affixing the QR code to an exterior of the particular shipping container;
scanning the QR code with a GPS-enabled portable electronic computer device at a point of shipping origin;
determining the geographic location of the particular shipping container at the time of scanning the QR code using GPS location technology provided via the GPS-enabled portable electronic computer device;
capturing data including the specific identifying information from the scanned QR code and the determined geographic location of the particular shipping container at the time of scanning the QR code;
transmitting the scanned and captured data and geographic location to a computer database server supporting one or more container management websites with asset tracking software installed;
allowing a first user on a first computer server device to access the database server via the one or more container management websites and obtain the identifying information and location tracking information of the plurality of shipping containers including the particular shipping container;
allowing a second user on a second user computer device to access the first user computer server and search for the current geographic location of one or more of the plurality of shipping containers, as well as the identifying information of each of the one or more plurality of shipping containers; and
performing a search in the database server until a match is made for the one or more shipping containers and sending an automated email notification to at least the second user when the particular shipping container is identified, including the current geographical location of the shipping container.

2. The method as recited in claim 1 further comprising the steps of:
scanning the QR code on the particular shipping container at any point in time during transit of the particular shipping container to a final destination;
determining the current geographical location of the particular shipping container at the time of scanning the QR code using GPS location technology provided via the GPS-enabled portable electronic device; and
transmitting the current geographical location of the particular shipping container to the computer database server.

3. The method as recited in claim 2 further comprising the step of:
sending an automated email notification to at least one user with the current geographical location of the particular shipping container at a most recent time of scanning the QR code.

4. The method as recited in claim 1 further comprising the step of:
presenting a GPS map display on a monitor connected to at least the first computer server device or the second user computer device, and the GPS map display showing the current location of at least one of the plurality of shipping containers.

5. The method as recited in claim 1 wherein the QR code is a dynamic QR code.

6. The method as recited in claim 5 further comprising the step of:
scanning the dynamic QR code with the GPS-enabled portable electronic computer device and obtaining at least one URL from the dynamic QR code to link the GPS-enabled portable electronic computer device to the one or more container management websites.
